(19) United States
(12) Patent Application Publication
(10) Pub. No.: US 2008/0314930 A1
(43) Pub. Date: Dec. 25, 2008

(54) Liquid container valve system

(76) Inventor: Theodore A. Green, Westminister, CA (US)

Correspondence Address: Cislo & Thomas LLP, 1333 2nd Street, Suite #500, Santa Monica, CA, 90401-4110, US

(21) Appl. No.: 12/229,274

(22) Filed: Aug. 21, 2008

Related U.S. Application Data
(63) Continuation-in-part of application No. 11/410,667, filed on Apr. 26, 2006.

(51) Int. Cl. B67D 5/06

(52) U.S. Cl. 222/185.1; 222/484

(57) ABSTRACT

A beverage dispenser for use in combination with a container with a neck, having a dispenser body with a stabilizing base and a hub. The hub has an upwardly facing socket to accept the container's neck. A spigot assembly is mounted to the dispenser body and has a valve body and a spigot cap. A liquid passageway and an air relief passageway each separately connect the socket to the spigot assembly. A vent tube extends from the air relief passageway into the container, and an air valve is connected to the vent tube. Actuation of the spigot cap to an on position opens the liquid passageway as well as the air relief passageway to ambient air, permitting air within the container to equilibrate with ambient air via the interconnection of the vent tube, air relief passageway, and an air channel within the valve body, and permits beverage to exit the container and travel through the liquid passageway to be dispensed from the beverage dispenser at a dispensing port portion of the spigot assembly.

### CROSS-REFERENCES TO RELATED APPLICATIONS

This patent application claims the benefit of and is a continuation in part of U.S. patent application Ser. No. 11/410,667 filed Apr. 26, 2006 for Liquid Container Valve System, which application is incorporated here by this reference.

### TECHNICAL FIELD

This invention relates to a valve system for dispensing liquid from a container, such as a plastic beverage container, in a controlled manner.

### BACKGROUND ART

Plastic bottles with threaded necks are now extensively used as commercial containers for beverages sold to consumers. Plastic bottles of this type are widely utilized as containers for soft drinks, nonalcoholic drink mixes, bottled water, and other beverages. Beverage containers of this type are widely sold in supermarkets and grocery stores. Beverages are sold in plastic bottles having a wide variety of sizes, ranging from small sizes of just a few ounces, up to larger sizes of one, two, and even three liters.

Conventional plastic beverage containers are produced with narrow necks at their upper extremities that surround open mouths through which the beverages are poured. The necks are externally threaded to receive an internally threaded plastic or metal cap. The threads are configured so that the cap, when threadably engaged upon the neck of the container, is sealed fluid tight.

When consumers open plastic beverage containers of this type to dispense beverages therefrom, care must be taken in holding the container so that the contents are not spilled while tilting the container to pour the beverage therefrom into a cup or glass. To reduce the cost of plastic beverage bottles the container walls are typically rather thin. Due to the resiliency of the structure of plastic beverage containers, the contents can easily be spilled during pouring of the beverage due in large part to the flexible nature of the walls of the beverage container. This problem is particularly acute in pouring beverages from containers of larger sizes, such as two and three-liter plastic bottles. It is not at all uncommon for portions of the plastic wall of the bottle to collapse suddenly under pressure exerted by the fingers of the individual pouring the beverage as liquid is being poured. When this occurs the beverage often spills.

Spills while pouring beverages from large plastic beverage containers quite often occur when the beverage is being poured by a child. Due to the small size of a child's hands, and inexperience in controlling the position of the beverage bottle, children frequently spill beverages when pouring them from their plastic containers into cups or glasses. Such spills not only represent a waste of the beverage, but also require cleanup. Furthermore, when beverages spill in this manner the spilled liquid soils table cloths and napkins, and renders paper table cloths and paper napkins unusable.

The manufacturers of wine in a box containers outsell their competitors two to one due to the convenience of having wine in a large container that is easily accessible on a refrigerator shelf or picnic table. However, the wine in such containers is stored in a collapsible bladder, unlike plastic soft drink and other beverage containers which are stiff enough so that they can hold their shape on the shelves of a retail supermarket and during storage by the consumer once purchased.

The use of two liter bottles by consumers is not particularly convenient due to their size and weight. However, the cost of a two liter plastic bottle is considerably less than the cost of an equivalent amount of twelve ounce cans. Furthermore, the two liter bottles themselves represent an attractive marketing package to consumers. Therefore, two liter plastic beverage bottles are widely utilized to package consumer beverages sold for off-premises consumption.

### DISCLOSURE OF INVENTION

The present invention provides an apparatus for controlling delivery of a beverage, particularly from an inverted beverage container. The apparatus may be considered to be a beverage dispenser for use in combination with a beverage container with a neck, the beverage dispenser having a dispenser body, a spigot assembly, a liquid passageway, an air relief passageway, an air channel, a vent tube, and an air valve.

The dispenser body includes a stabilizing base and a hub on the stabilizing base. The hub has an upwardly facing socket, and the socket is shaped to accept the neck of the beverage container.

The spigot assembly is mounted to the dispenser body, and it includes a valve body and a spigot cap. The spigot cap has a valve closure element that extends and retracts within the valve body upon actuation of the spigot cap.

The liquid passageway connects the socket to the spigot assembly by way of a liquid drain port in the socket. Similarly, the air relief passageway connects the socket to the spigot assembly through an air relief port in the socket. The air relief passageway is separate from the liquid passageway.

The air channel is within the valve body of the spigot assembly and selectively connects and disconnects the air relief passageway to ambient air surrounding the beverage dispenser upon actuation of the spigot cap.

The vent tube extends from the air relief passageway into the beverage container, and it provides an air passage between the air relief passageway and the valve end of the vent tube.

The air valve is connected to the valve end of the vent tube and permits pressurized air to escape the beverage container through the vent tube as well as ambient air to enter the beverage container through the vent tube.

Actuation of the spigot cap (typically by rotating the spigot cap) to an on position opens the liquid passageway as well as the air relief passageway to ambient air. This permits air within the beverage container to equilibrate with ambient air via the interconnection of the vent tube, air relief passageway, and air channel. This also permits beverage to exit the beverage container and travel through the liquid passageway to be smoothly dispensed from the beverage dispenser at a dispensing port portion of the spigot assembly.

Actuation of the spigot cap to an off position closes the liquid passageway from the ambient air since the valve closure element blocks the dispensing port, and closes the air relief passageway from the ambient air since the valve closure element blocks the air relief passageway from the air channel. This prevents beverage from exiting the beverage dispenser and air from entering or exiting the beverage container.

The invention may be described with greater clarity and particularity by reference to the accompanying drawings.

### BRIEF DESCRIPTION OF DRAWINGS

FIG. 1 is a perspective view illustrating the dispenser of the invention employed in combination with a two liter plastic beverage container.

FIG. 2 is a sectional detail illustrating the operative components of the liquid dispenser of the invention.

FIGS. 3A-3C are sectional details of the spigot assembly of FIG. 2 showing various positions of the components when operated.

FIGS. 4A-4C are graphical illustrations of the approximate position of a bayonet pin in a thread groove of the spigot assembly, corresponding to the positions shown in FIGS. 3A-3C.

FIGS. 5A-5C are graphical representations of the flow of air within an air valve, corresponding to the positions shown in FIGS. 3A-3C.

FIG. 6 is a perspective view illustrating a portion of the interior of the spigot assembly.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

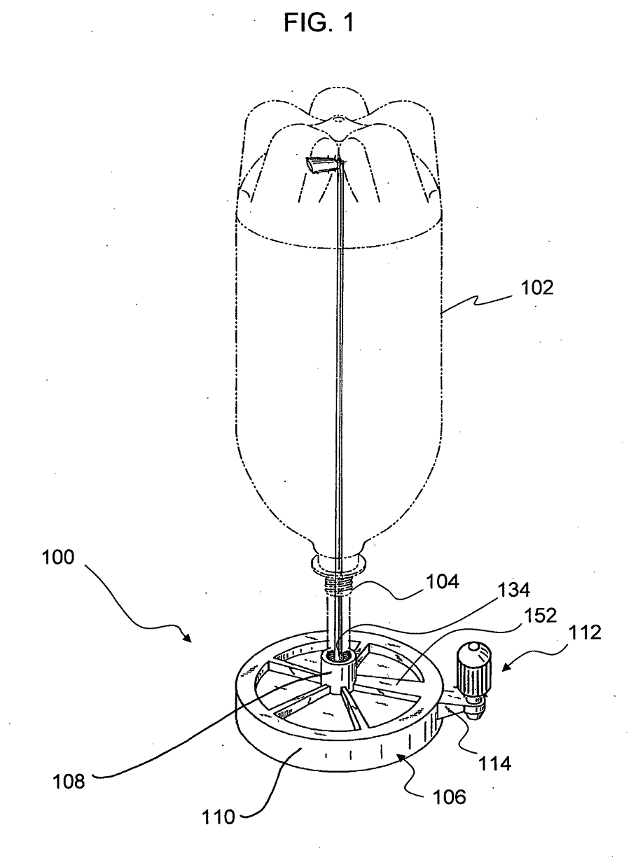

As illustrated in FIG. 1, a beverage dispenser 100 is shown in combination with a beverage container 102, such as a two liter plastic bottle. The beverage container 102 is inverted when utilized in combination with the beverage dispenser 100 and has a mouth surrounded by a threaded neck 104.

The beverage dispenser 100 has a dispenser body 106 with a flat underside and is formed as a spoked, wheel-shaped structure with a hub in the shape of a concave upwardly facing socket 108. The dispenser body 106 also has a peripheral rim 110 upon which a spigot assembly 112, or tap, is mounted by means of a spigot arm 114.

The spigot assembly 112 includes a spigot cap 116, or valve closure cap, having a valve closure element 118 that extends coaxially down the hollow center of a valve body 120. Rotation of the spigot cap 116 in a clockwise direction carries the valve closure element 118 downwardly, blocking a dispensing port 126. Counter-rotation of the spigot cap 116 retracts the valve closure element 118 upwardly, allowing liquid to flow out of the dispensing port 126, as indicated by the directional arrow 128. The spigot assembly 112 thereby is utilized to dispense liquid in a highly controlled manner into one or more drinking cups 130 for consumption.

The spigot assembly 112 is also used to control the flow of air into and out of the beverage container 102. Specifically, the grooves or threads 117 on the spigot cap 116 preferably permit full retraction of the valve closure element 118 in half a twist of the spigot cap 116; consequently, a portion of the thread grooves 117 are preferably nearly vertical. On a bottle of soda, the thread grooves are nearly horizontal to provide torque to hold the cap tightly to the bottle and to prevent high pressure CO2 from escaping. The present spigot assembly 112 preferably combines both of these functions, having thread grooves 117 that are nearly horizontal at one end and transition to nearly vertical at the other end of the groove 117. Preferably, the spigot cap 116 includes two or more bayonet pins 119, each of which engages a corresponding thread groove 117.

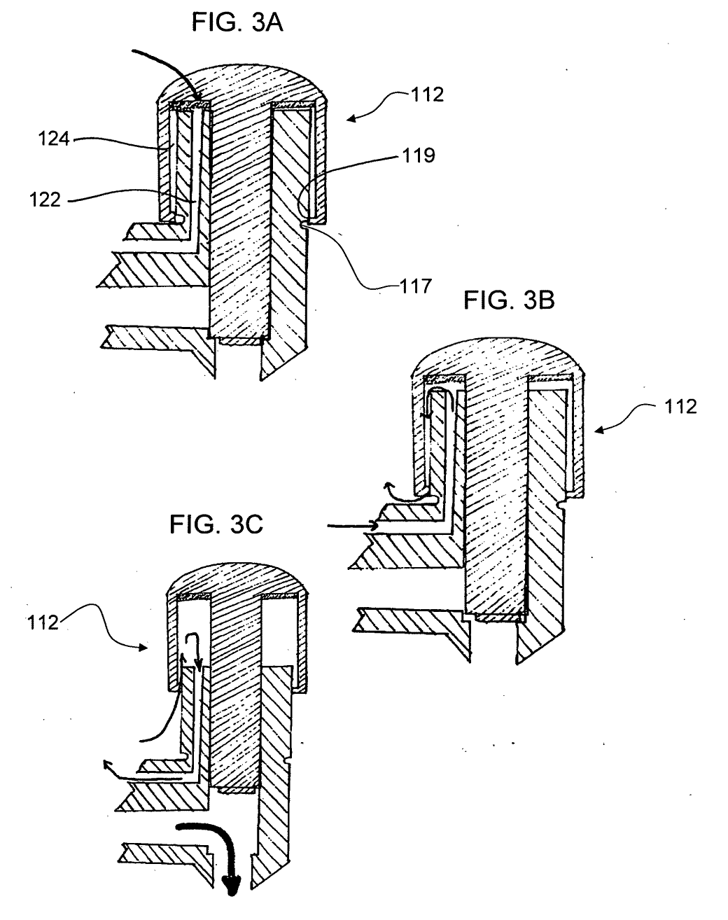

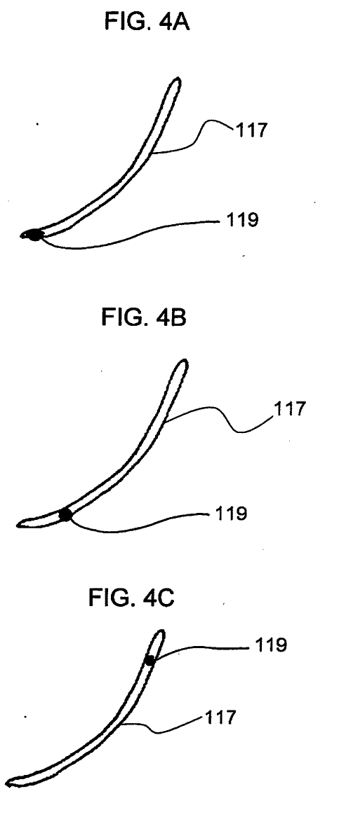

In FIG. 3A, the spigot assembly 112 is fully closed. In this position, the air relief passageway 164 terminates inside the spigot cap 116 since it is blocked by the underside of the spigot cap 116, thus preventing CO2 from escaping the beverage container 102. The bayonet pins 119 of the cap are at the nearly horizontal portion of the twin semi-spiral grooves 117 cut into the side of the valve body 120, such as shown in FIG. 4A.

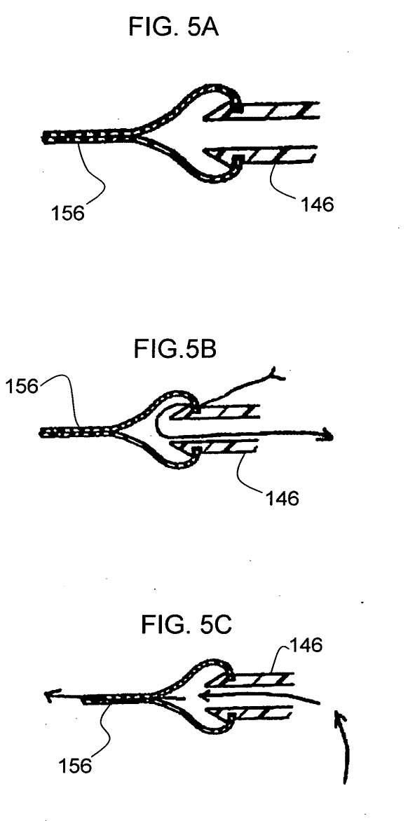

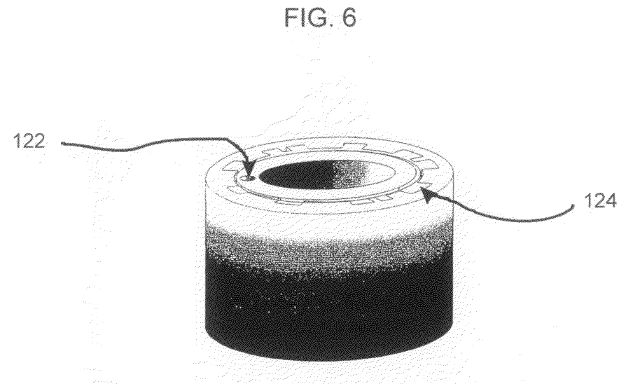

FIG. 3B shows the spigot cap 116 after it is given a half twist from the position shown in FIG. 3A. In FIG. 3B, the air relief passageway 164 is opened, allowing CO2 to escape the beverage container 102, first through the air valve 156 (FIG. 5B), then down the vent tube 146, through the spigot cap 116, past the air gaps 124 in the spigot cap 116 (FIG. 6) and out. Since the bayonet pins 119 in the spigot cap 116 are in the nearly horizontal portion of the grooves 117 (such as shown in FIG. 4B), the valve closure element 118 is not retracted enough to allow the liquid beverage 158 to flow from the dispensing port 126. At this stage, the liquid beverage 158 is no longer under high pressure, eliminating the need for a tight seal design.

In FIG. 3C, another half twist of the spigot cap 116 moves the bayonet pins 119 through the nearly vertical portion of the grooves 117 (such as shown in FIG. 4C), thus fully retracting the valve closure element 118 and allowing the liquid beverage 158 to flow from the dispensing port 126. As the beverage evacuates the bottle, low pressure within the beverage container 102 pulls air back through the air gaps 124 in the spigot cap 116, through the vent tube 146, and out though the air valve 156 (FIG. 5C).

FIG. 6 is a depiction of the top inside of the spigot cap 116 and the shaft of the valve closure element 118. The one or more air gaps 124 in the spigot cap 116 provide rigidity and a path for ambient air to reach the end of the one or more air channels 122 in the valve body 120.

The socket 108 has a cylindrical annular upwardly projecting socket wall 132 having an upper portion that is formed with internal screw threads 134. The screw threads 134 are of the same size and pitch as the threads on the threaded neck 104 of the beverage container 102. Therefore, when the beverage container 102 is in an upright condition opposite that illustrated in the drawings, the cap with which it is sold can be removed and the beverage dispenser 100 can be attached to the bottle's threaded neck 104 by screwing the socket 108 onto the threaded neck 104. A fluid tight seal is created between the threaded neck 104 of the beverage container 102 and the socket 108. The socket 108 is formed with a transverse socket floor 140 that is located at the bottom of the socket wall 132. The socket wall 132 surrounds the socket floor 140 and rises from it.

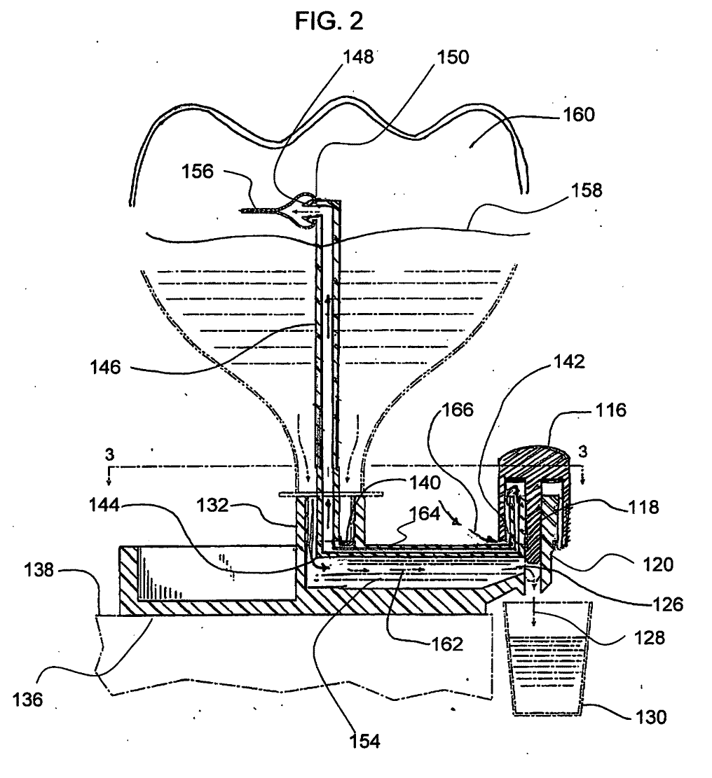

The combination of the beverage container 10 2 mounted to the beverage dispenser 100 can then be turned upside down. The flat underside 136 of the dispenser body 106 can be placed atop a flat serving surface, such as the table or countertop 138 indicated in FIG. 2. Consequently, the dispenser body 106 provides a stabilizing base when the beverage container 102 is mounted to the beverage dispenser 100.

A central air relief port 142 is defined in the socket floor 140 of the socket 108, and a separate drain port 144 is also formed in the socket floor 140. The drain port 144 is separate and is isolated from the air relief port 142.

The socket 108 is also provided with a vent tube 146, or inlet tube, that extends upwardly from the air relief port 142 in the socket floor 140. The air vent tube 146 extends above the top of the socket wall 132, which may be annular, and terminates in a distal tip 148 with an annular check valve-engaging barbed neck or collar 150 located immediately beneath the distal tip 148. The air vent tube 146 preferably extends above the level of liquid beverage 158 at the upper region 160 of the beverage container 102. As shown in FIG. 2, the distal tip 148 is preferably perpendicular to the remainder of the air vent tube 146.

The dispenser body 106 is formed with a plurality of spokes 152 extending between the socket 108 and the peripheral rim 110. One spoke 152 is hollow and forms a liquid passageway 154 that extends laterally outwardly from the drain port 144 to the dispensing port 126, which is opened and closed by the spigot assembly 112. The remaining spokes 152 are preferably solid and provide rigidity to the dispenser body 106.

The air valve 156 is preferably formed from a single, soft, flexible rubber sheet and may be constructed as disclosed in Green Ser. No. 11/410,667 (Publication US 2007/0251955). As illustrated in FIG. 2, a first end of the flexible rubber air valve 156 is attached to the distal tip 148 of the vent tube 146 in releaseable, but fluid tight engagement by stretching the air valve 156 so that the distal tip 148 of the vent tube 146 can be inserted into the air valve 156. The material comprising the air valve 156 is resilient enough so that a fluid tight seal is formed between the first end of the air valve 156 and the collar 150 below the distal tip 148 of the vent tube 146.

The air valve 156 is releaseably engaged on the vent tube 146, as illustrated in FIG. 1, prior to attachment of the socket 108 to the threaded neck 104 of the beverage container 102.

Once the bottle's threaded neck 104 has been screwed into the socket 108 and the beverage dispenser 100 and once the beverage container 102 is inverted, as illustrated in FIG. 2, liquid will flow down into the open mouth of the beverage container 102, but cannot escape through the drain port 144 until such time as the spigot assembly 112 is opened. Due to the trapezoidal construction and the flexible nature of the material comprising the air valve 156, the end of the air valve 156 opposite the first end will remain collapsed with the layers forming the upper end of the air valve 156 pressed together. Should the beverage container 102 be returned upright or positioned in a fashion that would submerge the air valve 156 in the pressurized beverage 158, the upper end of the air valve 156 will remain pressed together by the hydrostatic pressure of the liquid beverage 158 in the beverage container 102.

The dispenser body 106 is positioned on the serving surface 138 so that the spigot assembly 112 projects outwardly beyond the edge of the serving surface 138, held in cantilever fashion by the spigot arm 114. The spigot cap 116 of the spigot assembly 112 can them be opened and closed very easily to dispense the liquid beverage 158 into the drinking cups 130 as each drinking cup 130 is brought into position beneath the outlet of the spigot assembly 112.

The beverage container 102 has a structure that is sufficiently rigid so that it will collapse to only a limited extent as the liquid beverage 158 flows out of the beverage container 102 and into the drinking cups 130 as controlled by the spigot assembly 112. As a consequence, without the air valve 156 of the invention, a partial vacuum would be created in the upper region 160 of the beverage container 102 as liquid is drawn out of the mouth and through the liquid passageway 154 for dispensation into the drinking cups 130. The withdrawal of a significant volume of the liquid beverage 158 from the beverage container 102 would create a partial vacuum in the upper region 160 of the inverted beverage container 102. A partial vacuum would inhibit or completely halt liquid flow from the spigot assembly 112. However, the air valve 156 permits the volume of liquid beverage 158 being withdrawn from the beverage container 102 to be replaced by ambient air. As liquid flows out of the beverage container 102, as indicated by the directional arrow 162, air flows into the air relief passageway 164 defined in the dispenser body 106 beneath the socket floor 140, as indicated by the directional arrow 166.

The pressure of ambient air acts through the air relief port 142, within the vent tube 146, and allows air to bubble upwardly, momentarily spreading apart the upper ends of the trapezoidal portions 160 and 162 of the air valve 156. Air is thereby vented into the beverage container 102 to replace the volume of the liquid beverage 158 dispensed and to equalize pressure within the beverage container 102 so that dispensation of beverage flow through the spigot assembly 112 is not disrupted. The relief of air pressure through the air valve 156 within the beverage container 102 allows liquid beverage to flow smoothly out of the beverage dispenser 100 and into the drinking cups 130, as controlled by the spigot assembly 112.

When used in a non-carbonated beverage application, such as disclosed in Green Ser. No. 11/410,667 (Publication US 2007/0251955), the hydrostatic pressure of the liquid beverage 158 within the lower portion of the beverage container 102 normally holds the upper ends of the trapezoidal portions 160 and 162 of the air valve 156 in face to face contact with each other, thereby creating a fluid tight seal. However, due to the sandwich-like construction of the trapezoidal portions 160 and 162, air is allowed to pass between the two rubber layers forming the air valve 156 when a vacuum builds up in the upper region 160 of the beverage container 102 as the liquid beverage 158 is drained out through the drain port 144. As the partial vacuum develops in the beverage container 102, air is allowed to pass between the trapezoidal portions 160 and 162 when there is a lower pressure inside the beverage container 102 relative to ambient atmosphere. However, the liquid beverage 158 is unable to escape between the trapezoidal portions 160 and 162 and into the vent tube 146, since the hydrostatic pressure of the liquid beverage causes the trapezoidal portions 160 and 162 to collapse back against each other, once the air bubbles pass between them. In the configuration for carbonated beverages, the air valve 156 is not submerged but, due to its construction, will keep the liquid beverage out of the vent tube 146, even if the beverage container 102 is in a position other than perpendicular to a flat surface such as when it is transported or accidently knocked over.

While the combination of the inverted beverage container 102 with the beverage dispenser 100 is illustrated in FIG. 2 for dispensing liquid over the edge of a supporting surface, such as a table 138, it can also be stored in this condition in a refrigerator. Thus, the beverage container 102 can sit cold on a refrigerator shelf with the spigot assembly 112 extending just beyond the shelf. The straight liquid passageway 154 leading from the socket 108 of the dispenser body 106 gives the beverage dispenser 100 a low profile. This ensures that the beverage container 102 and the beverage dispenser 100 can fit on a typical refrigerator shelf.

While the present invention has been described with regards to particular embodiments, it is recognized that additional variations of the present invention may be devised without departing from the inventive concept. For example, different types of check valves can be employed in place of the air valve 156 illustrated in the drawings. Also, the configuration of the dispenser body 106 of the beverage dispenser 100 can have many different shapes.

### INDUSTRIAL APPLICABILITY

This invention may be industrially applied to the development, manufacture, and use of valve systems for dispensing liquid from a container, such as a plastic beverage container, in a controlled manner.

What is claimed is:

1. A beverage dispenser for use in combination with an inverted beverage container that has a threaded neck, the beverage dispenser comprising:
(a) a dispenser body, the dispenser body comprising a spoked, wheel-shaped structure having a flat underside, the dispenser body further having a hub centered on the wheel-shaped structure, the hub including an upwardly facing, annular socket, the socket being internally threaded to accept the threaded neck of the beverage container, the dispenser body also having a peripheral rim;
(b) a manually operable spigot assembly mounted to the peripheral rim of the dispenser body by way of a spigot arm, the spigot assembly comprising a valve body and a spigot cap, the spigot cap having a valve closure element that extends coaxially within a hollow center of the valve body upon rotation of the spigot cap, the spigot cap being connected to the valve body by a plurality of bayonet pins engaging a corresponding plurality of thread grooves, each of the plurality of thread grooves being nearly horizontal at a first end and transitioning to being nearly vertical at an opposite, second end of the groove;
(c) a liquid passageway connecting the socket to the spigot assembly by way of a liquid drain port in the bottom of the socket;
(d) an air relief passageway connecting the socket at a socket end of the air relief passageway to the spigot assembly through an air relief port in the bottom of the socket, the air relief passageway being separate from the liquid passageway;
(e) an air channel within the valve body of the spigot assembly, the air channel selectively connecting and disconnecting the air relief passageway to ambient air surrounding the beverage dispenser upon rotation of the spigot cap;
(f) a vent tube having a socket end and a valve end, the vent tube extending from the socket end of the air relief passageway into the beverage container, the vent tube providing an air passage between the air relief passageway and the valve end of the vent tube, the valve end of the vent tube being generally perpendicular to the remainder of the vent tube; and
(g) a bidirectional air valve releaseably connected to the valve end of the vent tube, the air valve made of flexible rubber, the air valve comprising a collapsible, tubular structure having an inlet collar and an outlet opening, the inlet collar surrounding the valve end of the vent tube, the air valve permitting pressurized air to escape the beverage container through the vent tube and permitting ambient air to enter the beverage container through the vent tube;
whereby rotation of the spigot cap to an on position opens the liquid passageway as well as the air relief passageway to ambient air, permitting air within the beverage container to equilibrate with ambient air via the interconnection of the vent tube, air relief passageway, and air channel, thus permitting beverage to exit the beverage container and travel through the liquid passageway to be smoothly dispensed from the beverage dispenser at a dispensing port portion of the spigot assembly;
whereby rotation of the spigot cap to an off position closes the liquid passageway from the ambient air by the valve closure element blocking the dispensing port, and closing the air relief passageway from the ambient air by the valve closure element blocking the air relief passageway from the air channel, thus preventing beverage from exiting the beverage dispenser and air from entering or exiting the beverage container.

2. A beverage dispenser for use in combination with a beverage container with a neck, the beverage dispenser comprising:
(a) a dispenser body, the dispenser body comprising a stabilizing base, the dispenser body further having a hub on the stabilizing base, the hub comprising an upwardly facing socket, the socket being shaped to accept the neck of the beverage container, the dispenser body also having a peripheral rim;
(b) a spigot assembly mounted to the peripheral rim of the dispenser body, the spigot assembly comprising a valve body and a spigot cap, the spigot cap having a valve closure element that extends and retracts coaxially within a hollow center of the valve body upon actuation of the spigot cap;
(c) a liquid passageway connecting the socket to the spigot assembly by way of a liquid drain port in the socket;
(d) an air relief passageway connecting the socket at a socket end of the air relief passageway to the spigot assembly through an air relief port in the socket, the air relief passageway being separate from the liquid passageway;
(e) an air channel within the valve body of the spigot assembly, the air channel selectively connecting and disconnecting the air relief passageway to ambient air surrounding the beverage dispenser upon actuation of the spigot cap;
(f) a vent tube having a socket end and a valve end, the vent tube extending from the socket end of the air relief passageway into the beverage container, the vent tube providing an air passage between the air relief passageway and the valve end of the vent tube; and
(g) an air valve connected to the valve end of the vent tube, the air valve permitting pressurized air to escape the beverage container through the vent tube and permitting ambient air to enter the beverage container through the vent tube;
whereby actuation of the spigot cap to an on position opens the liquid passageway as well as the air relief passageway to ambient air, permitting air within the beverage container to equilibrate with ambient air via the interconnection of the vent tube, air relief passageway, and air channel, thus permitting beverage to exit the beverage container and travel through the liquid passageway to be smoothly dispensed from the beverage dispenser at a dispensing port portion of the spigot assembly;
whereby actuation of the spigot cap to an off position closes the liquid passageway from the ambient air by the valve closure element blocking the dispensing port, and closing the air relief passageway from the ambient air by the valve closure element blocking the air relief passageway from the air channel, thus preventing beverage from exiting the beverage dispenser and air from entering or exiting the beverage container.

3. The beverage dispenser of claim 2, the stabilizing base comprising a spoked, wheel-shaped structure.

4. The beverage dispenser of claim 3, the hub being centered on the wheel-shaped structure.

5. The beverage dispenser of claim 2, the socket being an annular socket.

6. The beverage dispenser of claim 2, the neck of the beverage container being threaded and the socket being internally threaded to accept the threaded neck of the beverage container.

7. The beverage dispenser of claim 2, the spigot assembly being mounted to the peripheral rim of the dispenser body by way of a spigot arm.

8. The beverage dispenser of claim 2, the spigot cap being connected to the valve body by a plurality of bayonet pins engaging a corresponding plurality of thread grooves.

9. The beverage dispenser of claim 8, each of the plurality of thread grooves being nearly horizontal at a first end and transitioning to being nearly vertical at an opposite, second end of the groove.

10. The beverage dispenser of claim 2, the liquid drain port being in the bottom of the socket.

11. The beverage dispenser of claim 2, the air relief port being in the bottom of the socket.

12. The beverage dispenser of claim 2, the valve end of the vent tube being generally perpendicular to the remainder of the vent tube.

13. The beverage dispenser of claim 2, the air valve being releaseably connected to vent tube.

14. The beverage dispenser of claim 2, the air valve being made of flexible rubber.

15. The beverage dispenser of claim 2, the air valve comprising a collapsible, tubular structure having an inlet collar and an outlet opening, the inlet collar surrounding the valve end of the vent tube.

16. A liquid dispenser comprising:
(a) a stabilizing base having an attachment receptacle for creating a fluid-tight connection with a container having liquid;
(b) a spigot assembly mounted to the stabilizing base, the spigot assembly comprising a valve body and a spigot cap, the spigot cap having an extension that extends and retracts inside the valve body upon actuation of the spigot cap;
(c) a liquid passageway permitting the flow of liquid from the attachment receptacle to the spigot assembly;
(d) an air relief passageway permitting the flow of air from the attachment receptacle to the spigot assembly, the air relief passageway being separate from the liquid passageway;
(e) an air channel within the valve body of the spigot assembly, the air channel selectively connecting and disconnecting the air relief passageway to ambient air surrounding the liquid dispenser upon actuation of the spigot cap;
(f) a vent tube having a mounted end and a valve end, the vent tube extending outward from the attachment receptacle into the container, the vent tube providing an interconnected air passage between the air relief passageway and the valve end of the vent tube; and
(g) an air valve at the valve end of the vent tube, the air valve permitting air to both escape and enter the container through the vent tube;
whereby actuation of the spigot cap to an on position opens the liquid passageway as well as the air relief passageway to ambient air, permitting air within the container to equilibrate with ambient air through the interconnected vent tube, air relief passageway, and air channel, and permitting liquid to flow from the container and travel through the liquid passageway to exit the liquid dispenser at a dispensing port portion of the spigot assembly;
whereby actuation of the spigot cap to an off position closes the liquid passageway from the ambient air by the valve closure element blocking the dispensing port, and closing the air relief passageway from the ambient air by the valve closure element blocking the air relief passageway from the air channel, thus preventing liquid from exiting the liquid dispenser and air from entering or exiting the container.

17. The beverage dispenser of claim 16, the spigot cap being connected to the valve body by a plurality of bayonet pins engaging a corresponding plurality of thread grooves.

18. The beverage dispenser of claim 17, each of the plurality of thread grooves being nearly transverse to a longitudinal axis of the spigot cap at a first end and transitioning to being nearly parallel to the longitudinal axis at an opposite end of the groove.

19. The beverage dispenser of claim 2, the valve end of the air valve being oblique to the vent tube.

20. The beverage dispenser of claim 16, the air valve comprising a collapsible, flexible, rubber, tubular structure having an inlet end and an outlet end, the inlet end being connected to the valve end of the vent tube to permit the flow of air between the vent tube and the air valve.
